(19) United States
(12) Patent Application Publication
(10) Pub. No.: US 2026/0332368 A1
(43) Pub. Date: Oct. 22, 2026

(54) BAND SWITCHING METHOD AND DEVICE, AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/115,574

(22) PCT Filed: Sep. 26, 2022
(86) PCT No.: PCT/CN2022/121341

§ 371 Date: Mar. 26, 2025

(51) Int. Cl. H04L 5/00

(52) U.S. Cl. CPC H04L 5/0098; H04L 5/0048

(57) ABSTRACT

A method for switching a band is provided by the present disclosure. The method for switching a band is performed by a terminal. The method for switching a band includes the following step: determining a switching mode for a band based on a priority of at least one band supported by the terminal.

### CROSS-REFERENCE TO RELATED APPLICATION

The present application is a U.S. National Stage of International Application No. PCT/CN2022/121341, filed on Sep. 26, 2022, the contents of all of which are incorporated herein by reference in their entirety for all purposes.

### BACKGROUND OF THE INVENTION

In a mobile communication system, a terminal can perform uplink transmission through a band. Currently, a terminal can perform switching between uplink antennas, that is, perform switching between bands targeted by the uplink antennas.

### SUMMARY OF THE PRESENT INVENTION

The present disclosure relates to the field of mobile communications, and in particular, to a method and device for switching a band, and a storage medium.

According to an aspect of the present disclosure, a method for switching a band is provided. The method is performed by a terminal, and includes: determining a switching mode for a band based on a priority of at least one band supported by the terminal.

According to another aspect of the present disclosure, a method for switching a band is provided. The method is performed by a network device, and includes: determining a priority of at least one band supported by a terminal, where the priority of the at least one band is configured to be used by the terminal to determine a switching mode for a band.

According to another aspect of the present disclosure, a device for switching a band is provided. The device includes: a processing module, configured to determine a switching mode for a band based on a priority of at least one band supported by a terminal.

According to another aspect of the present disclosure, a device for switching a band is provided. The device includes: a processing module, configured to determine a priority of at least one band supported by a terminal, where the priority of the at least one band is configured to be used by the terminal to determine a switching mode for a band.

According to another aspect of the present disclosure, a terminal is provided. The terminal includes: one or more processors; a transceiver connected to the one or more processors; and a memory configured to store processor-executable instructions, where the one or more processors are collectively configured to load and execute the processor-executable instructions to perform the method for switching the band as in the above aspect.

According to another aspect of the present disclosure, a network device is provided. The network device includes: one or more processors; a transceiver connected to the one or more processors; and a memory configured to store processor-executable instructions, where the one or more processors are collectively configured to load and execute the processor-executable instructions to perform the method for switching the band as in the above aspect.

According to another aspect of the present disclosure, a communication system is provided. The communication system includes a terminal and a network device, where the terminal is configured to perform the method for switching the band as in the above aspect, and the network device is configured to perform the method for switching the band as in the above aspect.

According to another aspect of the present disclosure, a non-transitory computer-readable storage medium is provided. The non-transitory computer-readable storage medium stores executable program codes, where the executable program codes are loaded and executed by one or more processors to implement the method for switching the band as in the above aspects.

According to another aspect of the present disclosure, a chip is provided. The chip includes at least one of a programmable logic circuit or a program instruction and is configured to perform the method for switching the band as in the above aspects when running on a terminal or a network device.

According to another aspect of the present disclosure, a computer program product is provided. The computer program product is configured to perform the method for switching the band as in the above aspects when executed by one or more processors of a terminal or a network device.

### BRIEF DESCRIPTION OF DRAWINGS

In order to more clearly illustrate the technical solution in the embodiments of the present disclosure, the accompanying drawings to be used in the description of the embodiments will be briefly introduced below. It will be apparent that the accompanying drawings in the following description are merely some of the embodiments of the present disclosure, and other accompanying drawings can be obtained according to these accompanying drawings for those of ordinary skill in the art without creative efforts.

FIG. 1 shows a block diagram of a communication system according to an example of the present disclosure.

FIG. 2 shows a flowchart of a method for switching a band according to an example of the present disclosure.

FIG. 3 shows a flowchart of a method for indicating a band according to an example of the present disclosure.

FIG. 4 shows a flowchart of a method for indicating capability according to an example of the present disclosure.

FIG. 5 shows a block diagram of a device for switching a band according to an example of the present disclosure.

FIG. 6 shows a block diagram of a device for switching a band according to another example of the present disclosure.

FIG. 7 shows a block diagram of a device for switching a band according to an example of the present disclosure.

FIG. 8 shows a block diagram of a device for switching a band according to another example of the present disclosure.

FIG. 9 shows a schematic structural diagram of a communication device according to an example of the present disclosure.

### DETAILED DESCRIPTION OF THE PRESENT INVENTION

In order to make the purpose, technical solution and advantages of the present disclosure clearer, the implementations of the present disclosure will be described in further detail below in conjunction with the accompanying drawings.

Examples will be illustrated in detail, examples of which are expressed in the accompanying drawings. When the following description refers to the accompanying drawings, the same numbers in different accompanying drawings represent the same or similar elements unless otherwise indicated. The implementations as described in the following examples do not represent all the implementations consistent with the present disclosure, and rather, are merely examples of devices and methods consistent with some aspects of the present disclosure as detailed in the appended claims.

The terms used in the present disclosure are for the purpose of describing particular embodiments and are not intended to limit the present disclosure. The singular forms of “a”, “an”, “the”, and “this” used in the present disclosure and the appended claims are also intended to encompass the plural form, unless the context clearly indicates otherwise. It is also to be understood that the term “and/or” as used refers to and encompasses any or all possible combinations of one or more of listed items in association.

It is to be understood that although the terms such as first, second and third may be used in the present disclosure to describe various information, such information is not to be limited to these terms. These terms are used to distinguish the same type of information from one another. For example, without departing from the scope of the present disclosure, first information may also be referred to as second information, and similarly, second information may also be referred to as first information. For example, the word “if” as used may be interpreted as “at . . . ” or “when . . . ” or “in response to determining” depending on the context.

It needs to be noted that the information (including, but not limited to, user equipment information, user personal information, etc.), data (including, but not limited to, data for analysis, data stored, data displayed, etc.), and signals involved in the present disclosure are authorized by the user or fully authorized by the parties, and the collection, use, and processing of the relevant data needs to comply with relevant laws, regulations, and standards of the relevant countries and regions.

The terms involved in the present disclosure are explained first.

Band: a band refers to a frequency range. A band may have an identifier. Bands with different identifiers correspond to different frequency ranges. For example, bands include band 1, band 22, band 72, etc., each band corresponding to one frequency range.

Band switching: a terminal supports at least two uplink antennas and at least one band. Each uplink antenna can target one band. One band may be targeted by at most two uplink antennas. The term “target” means that a terminal may transmit uplink data to a targeted band through an uplink antenna. The term “band switching” means that one uplink antenna used by a terminal is switched from targeting one band to targeting another band.

Priority: refers to a priority corresponding to each band. A priority corresponding to each band is configured to indicate whether switching between bands can be performed.

In some embodiments, the priority includes a high priority and a low priority. That is, for one band, this band has either the high priority or the low priority.

Application scenarios of the present disclosure are described next.

FIG. 1 shows a block diagram of a communication system according to an example of the present disclosure. The communication system 30 may include a terminal 10 and a network device 20.

There may usually be a plurality of terminals 10, and one or more terminals 10 may be distributed within a cell managed by each network device 20. The terminal 10 may include a variety of handheld devices, in-vehicle devices, wearable devices, computing devices, or other processing devices connected to a wireless modem with a wireless communication function, as well as various forms of User Equipments (UEs), Mobile Stations (MSs), etc. For ease of description, the devices mentioned above are collectively referred to as terminal in the embodiments of the present disclosure.

The network device 20 may be a device deployed in an access network to provide a wireless communication function for the terminal 10. For ease of description, the above devices providing the wireless communication function for the terminal 10 are collectively referred to as network device in the embodiments of the present disclosure. A connection may be established between the network device 20 and the terminal 10 via a radio interface, so that communication, including signaling and data interaction, is performed through the connection. There may be a plurality of network devices 20, and communication between two adjacent network devices 20 may also be performed in a wired or wireless manner. The terminal 10 may perform beam report transmission between different network devices 20, that is, establish connections with different network devices 20.

The network device 20 may include various forms of macro base stations, micro base stations, relay stations, access points, etc. In a system using different wireless access technologies, the names of the devices having functions of the network device may be different, which, for example, are referred to as gNodeB or gNB in a 5G New Radio (NR) system. As communication technologies evolve, the name “network device” may change.

The “5G NR system” in the embodiments of the present disclosure may also be referred to as a 5G system or an NR system, and those skilled in the art can understand the meaning of the system. The technical solution described in the embodiments of the present disclosure may be applicable to the 5G NR system or a subsequent evolutionary system of the 5G NR system.

Currently, a terminal can perform switching between uplink antennas, that is, perform switching between bands targeted by the uplink antennas. However, for a case where a terminal supports different quantities of bands, how to realize band switching has become an urgent problem to be solved.

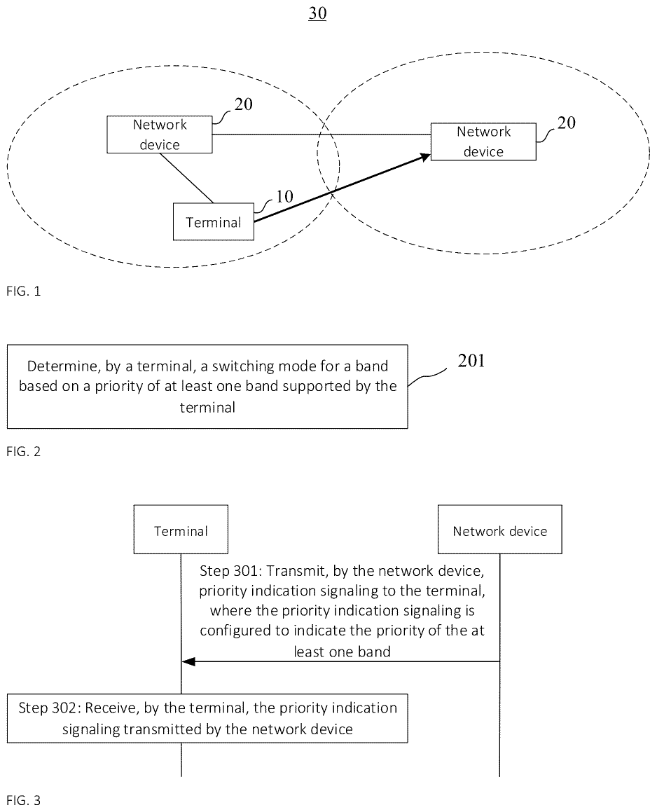

FIG. 2 shows a flowchart of a method for switching a band according to an example of the present disclosure. For example, the method may be performed by a terminal as shown in FIG. 1. The method includes at least part of the following contents.

Step 201 includes determining, by the terminal, a switching mode for a band based on a priority of at least one band supported by the terminal.

In an embodiment of the present disclosure, the terminal may be informed of at least one band supported by the terminal itself, and may determine a priority of each band based on the at least one band supported by the terminal. The priority of the band is configured to indicate whether switching between bands can be performed. The terminal can determine the switching mode for the band based on the priority of the at least one band supported by the terminal itself, and perform band switching based on the switching mode.

The switching mode refers to a way of indicating whether to support switching between at least two bands. For example, band 1 and band 2 may be switched between each other, or other bands may be switched between each other. The switching mode is not limited in the embodiments of the present disclosure.

The present disclosure provides a solution for determining the switching mode for the band based on the priority of the band, so that band switching can be performed based on the priority of the band, thus realizing dynamic switching by the terminal and reducing energy consumption of the terminal performing band switching.

It needs to be noted that the embodiments of the present disclosure are illustrated as an example of the terminal determining the switching mode for the band based on the priority of the band supported by the terminal itself. In another embodiment, the network device may also determine the priority of the band supported by the terminal, so as to facilitate both the network device and the terminal to clarify the priority of the band supported by the terminal, and thus determine the switching mode for the band.

In an embodiment of the present disclosure, the network device determines the priority of the at least one band supported by the terminal. The priority of the at least one band is configured to be used by the terminal to determine the switching mode for the band.

The network device may be informed of the priority of the at least one band supported by the terminal, and determine whether switching between bands can be performed based on the priority of the at least one band. The switching mode refers to a way of indicating whether switching is supported between at least two bands. For example, band 1 and band 2 may be switched between each other, or other bands may be switched between each other. The switching mode is not limited in the embodiments of the present disclosure.

The embodiment shown in FIG. 2 illustrates that the terminal may determine the switching mode for the band based on the priority of the band, and the following illustrates how to configure the priority of the band.

The first way to configure the priority of the band is that a network device configures the priority of the band for the terminal.

FIG. 3 shows a flowchart of a method for indicating a band according to an example of the present disclosure. The method may be for example performed by a terminal and a network device as shown in FIG. 1. The method includes at least part of the following contents.

Step 301 includes transmitting, by the network device, priority indication signaling to the terminal, where the priority indication signaling is configured to indicate a priority of at least one band.

Step 302 includes receiving, by the terminal, the priority indication signaling transmitted by the network device.

In an embodiment of the present disclosure, the network device may determine a priority of each of the at least one band supported by the terminal, and transmit the priority indication signaling to the terminal. Through the priority indication signaling, the priority of the at least one band can be indicated to the terminal. The terminal can determine the priority of each band supported by the terminal itself after receiving the priority indication signaling.

In some embodiments, the priority indication signaling includes a first quantity of bit. Each of the first quantity of bits is configured to indicate a priority of a corresponding band.

The first quantity is agreed upon by a communication protocol or set by the network device, and is not limited in the embodiments of the present disclosure. For example, the first quantity may be 4, 6, or other values.

In an embodiment of the present disclosure, each of the first quantity of bits included in the priority indication signaling corresponds to a priority of one band. That is, the priority indication signaling can indicate priorities of a plurality of bands by a plurality of bits.

Taking the terminal supporting 4 bands for example, the priority indication signaling can indicate priorities of 4 bands by 4 bits, the 4 bits corresponding to the 4 bands one to one. Assuming that the 4 bands supported by the terminal include band 1, band 2, band 3, and band 4, the priority indication signaling indicates the priorities of the 4 bands by 4 bits xxxx, where a first x corresponds to band 1, a second x corresponds to band 2, a third x corresponds to band 3, and a fourth x corresponds to band 4.

In some embodiments, the priority of the band includes a low priority and a high priority, and each bit may indicate the low priority and the high priority by 0 and 1, respectively. For example, 0 indicates the low priority and 1 indicates the high priority. Alternatively, 0 indicates the high priority and 1 indicates the low priority.

Assuming that 0 indicates the low priority, 1 indicates the high priority, and that the priority indication signaling includes 4 bits, namely, 0011, it means that band 1 and band 2 has the low priority, and band 3 and band 4 has the high priority.

In an example, the first quantity of bits are represented through a bitmap. The bitmap includes the first quantity of bits.

In some embodiments, the first quantity of bits included in the priority indication signaling may be greater than a second quantity of bands supported by the terminal. In this case, the terminal needs to determine which bits are valid.

In an example, in a case where the second quantity of bands supported by the terminal is less than the first quantity, a second quantity of high-order bits in the first quantity of bits indicate priorities of corresponding bands.

The second quantity of high-order bits refer to a first second quantity of bits in the first quantity of bits. For example, assuming that the first quantity of bits are xyzmnl and the second quantity is 4, the second quantity of high-order bits are xyzm.

In an example, in a case where the second quantity of bands supported by the terminal is less than the first quantity, a second quantity of low-order bits in the first quantity of bits indicate priorities of corresponding bands.

The second quantity of low-order bits refer to a last second quantity of bits in the first quantity of bits. For example, assuming that the first quantity of bits are xyzmnl and the second quantity is 4, the second quantity of low-order bits are zmnl.

It needs to be noted that the embodiments of the present disclosure are illustrated as an example that each of the first quantity of bits included in the priority indication signaling indicates a priority of a corresponding band. In another embodiment, the priority indication signaling may further indicate priorities of all bands by a third quantity of bits included in the priority indication signaling.

The priority indication signaling includes the third quantity of bits. Code points corresponding to the third quantity of bits are configured to indicate the priorities of all bands.

In an embodiment of the present disclosure, the third quantity of bits may indicate different code points. The different code points correspond to different priorities. The priority corresponding to the code points indicated by the third quantity of bits apply to all bands supported by the terminal.

In some embodiments, a value of the third quantity is 1, that is, the priority indication signaling indicates the priorities of all bands by 1 bit. For example, assuming that the code point indicated by the third quantity of bits is 0, it may mean that all bands have the low priority; assuming that the code point indicated by the third quantity of bits is 1, it may mean that all bands have the high priority. Alternatively, assuming that the code point indicated by the third quantity of bits is 0, it may mean that all bands have the high priority; assuming that the code point indicated by the third quantity of bits is 1, it may mean that all bands have the low priority.

The second way to configure the priority of the band is that the priority of the band is determined by default.

In an embodiment of the present disclosure, in a case where the priority indication signaling for configuring the priority and transmitted by the network device is invalid or no priority of bands is configured, the terminal defaults to a priority of at least one band.

The default priority of the at least one band is agreed upon by a communication protocol or specified in other ways, which is not limited in the embodiments of the present disclosure.

In an example, in a case where the priority indication signaling is invalid or not configured, the at least one band has the low priority by default.

In an example, in a case where the priority indication signaling is invalid or not configured, the at least one band has the high priority by default.

In some embodiments, the priority indication signaling being invalid includes all of the bits in the priority indication signaling being invalid, or some of the bits in the priority indication signaling being invalid.

It needs to be noted that the priority indication signaling may be in the form of at least one of: radio resource control (RRC) signaling, a media access control control element (MAC CE), or downlink control information (DCI) signaling. The RRC signaling is semi-static signaling. The DCI signaling is dynamic signaling.

That is to say, the priority indication signaling may be the RRC signaling. Alternatively, the priority indication signaling may be the MAC CE. Alternatively, the priority indication signaling may be the DCI signaling. Alternatively, the priority indication signaling may be a combination of at least two pieces of signaling. This is not limited in the embodiments of the present disclosure.

It needs to be noted that the embodiments of the present disclosure are illustrated as an example that the network device configures for the terminal, through the priority indication signaling, the priority of the at least one band supported by the terminal. In another embodiment, the terminal needs to first report its own supported bands, so as to facilitate the network device to configure the priority based on the bands reported by the terminal.

In some embodiments, the terminal transmits capability information to the network device. The capability information is configured to indicate at least one band supported by the terminal. The network device can determine, after receiving the capability information, the at least one band supported by the terminal based on the capability information.

For example, the terminal may report a band pair to the network device, that is, report 2 bands supported by the terminal itself to the network device. Alternatively, the terminal may report 3 bands to the network device. Alternatively, the terminal may report 4 bands to the network device.

It needs to be noted that the steps performed by the terminal in the embodiments of the present disclosure may form a new embodiment separately, and the steps performed by the network device may also form a new embodiment separately.

In the solution provided in the embodiments of the present disclosure, the network device configures, through different forms of priority configuration signaling, a priority for at least one band supported by the terminal, so as to facilitate the terminal to determine the switching mode based on the priority of the at least one band. In this way, dynamic switching by the terminal is realized. Moreover, the switching mode for the band is reduced by setting the priority, thus reducing energy consumption of the terminal performing band switching.

The embodiment shown in FIG. 2 illustrates that the terminal may determine the switching mode based on the priority of the band, and the following illustrates how to configure the priority of the band.

In an embodiment of the present disclosure, the terminal may report, through the capability information, at least one band supported by the terminal itself, so as to facilitate the network device to determine the capability information of the terminal.

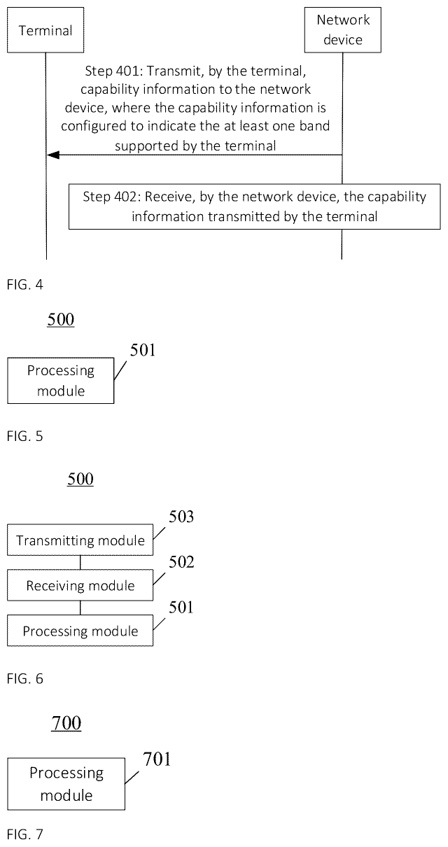

FIG. 4 shows a flowchart of a method for indicating capability according to an example of the present disclosure. The method may be for example performed by a terminal and a network device as shown in FIG. 1. The method includes at least part of the following contents.

Step 401 includes transmitting, by the terminal, capability information to the network device, where the capability information is configured to indicate at least one band supported by the terminal.

Step 402 includes receiving, by the network device, the capability information transmitted by the terminal.

In an embodiment of the present disclosure, the terminal transmits the capability information to the network device, where the capability information is configured to indicate at least one band supported by the terminal. The network device can determine, after receiving the capability information, the at least one band supported by the terminal based on the capability information.

For example, the terminal may report a band pair to the network device, that is, report 2 bands supported by the terminal itself to the network device. Alternatively, the terminal may report 3 bands to the network device. Alternatively, the terminal may report 4 bands to the network device.

In some embodiments, the terminal may also indicate a priority of the at least one band through the capability information transmitted.

In an embodiment of the present disclosure, the terminal determines the priority of the at least one band supported by the terminal itself, and carries, in the capability information reported, the priority of the at least one band supported by the terminal itself. In this way, the terminal may report the priority of the at least one band to the network device, and the network device can determine band switching that the terminal performs subsequently.

In an example, the capability information indicates an index identifier. The index identifier has a correspondence relationship with the at least one band supported by the terminal and the priority of each of the at least one band.

In an embodiment of the present disclosure, the terminal stores the correspondence relationship between the index identifier and the at least one band and the priority of each of the at least one band. The capability information can indicate the at least one band and the priority of each of the at least one band corresponding to the index identifier.

The correspondence relationship between the index identifier and the at least one band supported by the terminal and the priority of each of the at least one band is agreed upon by a communication protocol, or configured by the network device, or configured by the terminal, which is not limited in the embodiments of the present disclosure.

In some embodiments, the correspondence relationship between the index identifier and the at least one band and the priority of each of the at least one band is stored in a correspondence table. The at least one band supported by the terminal and the priority corresponding to each of the at least one band can be determined by querying the table.

For example, reference may be made to Table 1. Table 1 includes eight sets of correspondence relationships, where “L” represents the low priority and “H” represents the high priority.

TABLE 1

| Index Identifier | Band | Priority |
|---|---|---|
| NR_n3-n77-n78_1 | n3, n77, n78 | H, L, L |
| NR_n3-n77-n78_2 | n3, n77, n78 | L, H, L |
| NR_n3-n77-n78_3 | n3, n77, n78 | L, L, H |
| NR_n3-n77-n78_4 | n3, n77, n78 | H, H, L |
| NR_n3-n77-n78_5 | n3, n77, n78 | L, H, H |
| NR_n3-n77-n78_6 | n3, n77, n78 | H, H, H |
| NR_n3-n77-n78_7 | n3, n77, n78 | L, L, L |

For example, in a case where the index identifier is NR_n3-n77-n78_5, it means that the bands supported by the terminal are n3, n77, and n78, and the corresponding priorities are low priority, high priority, and high priority, respectively. Alternatively, in a case where the index identifier is NR_n3-n77-n78_7, it means that the bands supported by the terminal are n3, n77, and n78, and the corresponding priorities are low priority, low priority, and low priority, respectively.

It needs to be noted that the embodiments of the present disclosure are illustrated as an example that the terminal reports, through the capability information, the priority of the at least one band supported by the terminal itself. In another embodiment, the terminal determines the priority of the at least one band by default instead of indicating the priority of the at least one band through the capability information.

In some embodiments, in a case where the capability information does not indicate the priority of the at least one band, the at least one band has the low priority by default.

In some other embodiments, in a case where the capability information does not indicate the priority of the at least one band, the at least one band has the high priority by default.

In the solution provided in the embodiments of the present disclosure, the terminal may indicate the priority of the at least one band through the capability information reported to the network device. In this way, a solution for indicating the priority of the band is provided, and the accuracy of the indicated priority of the band is ensured. Further, it is ensured that the terminal may determine the switching mode based on the priority of the at least one band, thus realizing dynamic switching by the terminal. Moreover, the switching mode for the band is reduced by setting the priority, thus reducing energy consumption of the terminal performing band switching.

The embodiment shown in FIG. 2 illustrates that the terminal may determine the switching mode based on the priority of the band, and each switching mode is described in detail below.

In an embodiment of the present disclosure, the switching mode includes any one of the following.

### (1) Supporting Mutual Switching Between Bands Having a Same Priority.

In an embodiment of the present disclosure, in a case where a plurality of bands have the same priority, mutual switching is supported between the plurality of bands. For example, assuming that band 1 and band 2 both have the low priority, band 1 and band 2 can be switched between each other. Assuming that the terminal supports the switching of four bands, namely, band 1, band 2, band 3, and band 4, and band 1 and band 2 have the low priority and band 3 and band 4 have the high priority, then mutual switching is supported between band 1 and band 2 and is supported between band 3 and band 4, respectively.

### (2) Supporting Mutual Switching Between Bands Having Different Priorities and not Supporting Mutual Switching Between Bands Having a Same Priority.

In an embodiment of the present disclosure, in a case where a plurality of bands have different priorities from each other, mutual switching is supported between the plurality of bands. In a case where the plurality of bands have the same priority, mutual switching is not supported between the plurality of bands.

For example, assuming that band 1 has the high priority and band 2 has the low priority, band 1 and band 2 can be switched between each other. Assuming that both band 1 and band 2 have the high priority, mutual switching is not supported between band 1 and band 2. Assuming that the terminal supports the switching of four bands, namely, band 1, band 2, band 3, and band 4, and band 1 and band 2 have the low priority and band 3 and band 4 have the high priority, then mutual switching is supported between band 1 and band 3 or band 4 and is supported between band 2 and band 3 or band 4, respectively.

(3) Supporting Switching from a Band Having the Low Priority to a Band Having the High Priority, and not Supporting Switching from a Band Having the High Priority to a Band Having the Low Priority.

For example, assuming that band 1 has the high priority and band 2 has the low priority, it can be switched from band 2 to band 1, while it cannot be switched from band 1 to band 2. Assuming that the terminal supports the switching of four bands, namely, band 1, band 2, band 3, and band 4, and band 1 and band 2 have the low priority and band 3 and band 4 have the high priority, then switching from band 1 and band 2 to band 3 or band 4 is supported.

(4) Supporting Switching from a Band Having a High Priority to a Band Having a Low Priority, and not Supporting Switching from a Band Having the Low Priority to a Band Having the High Priority.

For example, assuming that band 1 has the high priority and band 2 has the low priority, it can be switched from band 1 to band 2, while it cannot be switched from band 2 to band 1. Assuming that the terminal supports the switching of four bands, namely, band 1, band 2, band 3, and band 4, and band 1 and band 2 have the low priority and band 3 and band 4 have the high priority, then switching from band 3 and band 4 to band 1 or band 2 is supported.

It needs to be noted that the embodiments of the present disclosure are illustrated as an example of bands. In another embodiment, each band includes at least one carrier, and carriers belonging to a same band have a same priority. As for the priority configuration related to the band in the present disclosure, the solution for determining the switching mode based on the priority of the band can all be applied to the carrier. The carrier involved in the present disclosure is described below by way of example.

In an embodiment of the present disclosure, a solution for configuring the priority of the carrier may be referred to the solution in which the network device configures the priority of the band through the priority indication signaling in the embodiments of the present disclosure, or referred to the solution in which the terminal configures the priority of the band by the terminal itself in the embodiments of the present disclosure. Alternatively, after the priority of the band is determined, the priority of the carrier belonging to the band can be determined based on the priority of the band, that is, the priority of the band is determined as the priority of the carrier included in the band.

In addition, the present disclosure provides a solution for determining a switching mode based on the priority of the carrier. In an embodiment of the present disclosure, the switching mode includes any one of the following.

### (1) Supporting Mutual Switching Between Carriers Having a Same Priority.

In an embodiment of the present disclosure, in a case where a plurality of carriers have a same priority, mutual switching is supported between the plurality of carriers. For example, assuming that carrier 1 and carrier 2 both have the low priority, carrier 1 and carrier 2 can be switched between each other. Assuming that the terminal supports the switching of four carriers, namely, carrier 1, carrier 2, carrier 3, and carrier 4, and carrier 1 and carrier 2 have the low priority and carrier 3 and carrier 4 have the high priority, then mutual switching is supported between carrier 1 and carrier 2 and is supported between carrier 3 and carrier 4, respectively.

### (2) Supporting Mutual Switching Between Carriers Having Different Priorities and not Supporting Mutual Switching Between Carriers Having a Same Priority.

In an embodiment of the present disclosure, in a case where a plurality of carriers have different priorities from each other, mutual switching is supported between the plurality of carriers. In a case where a plurality of carriers have a same priority, mutual switching is not supported between the plurality of carriers.

For example, assuming that carrier 1 has the high priority and carrier 2 has the low priority, carrier 1 and carrier 2 can be switched between each other. Assuming that both carrier 1 and carrier 2 have the high priority, mutual switching is not supported between carrier 1 and carrier 2. Assuming that the terminal supports the switching of four carriers, namely, carrier 1, carrier 2, carrier 3, and carrier 4, and carrier 1 and carrier 2 have the low priority and carrier 3 and carrier 4 have the high priority, then mutual switching is supported between carrier 1 and carrier 3 or carrier 4 and is supported between carrier 2 and carrier 3 or carrier 4, respectively.

(3) Supporting Switching from a Carrier Having the Low Priority to a Carrier Having the High Priority, and not Supporting Switching from a Carrier Having the High Priority to a Carrier Having the Low Priority.

For example, assuming that carrier 1 has the high priority and carrier 2 has the low priority, it can be switched from carrier 2 to carrier 1, while it cannot be switched from carrier 1 to carrier 2. Assuming that the terminal supports the switching of four carriers, namely, carrier 1, carrier 2, carrier 3, and carrier 4, and carrier 1 and carrier 2 have the low priority and carrier 3 and carrier 4 have the high priority, then switching from carrier 1 and carrier 2 to carrier 3 or carrier 4 is supported.

(4) Supporting Switching from a Carrier Having the High Priority to a Carrier Having the Low Priority, and not Supporting Switching from a Carrier Having the Low Priority to a Carrier Having the High Priority.

For example, assuming that carrier 1 has the high priority and carrier 2 has the low priority, it can be switched from carrier 1 to carrier 2, while it cannot be switched from carrier 2 to carrier 1. Assuming that the terminal supports the switching of four carriers, namely, carrier 1, carrier 2, carrier 3, and carrier 4, and carrier 1 and carrier 2 have the low priority and carrier 3 and carrier 4 have the high priority, then switching from carrier 3 and carrier 4 to carrier 1 or carrier 2 is supported.

It needs to be noted that the above embodiments may be split into new embodiments or combined with other embodiments as new embodiments, and the combination between embodiments is not limited in the present disclosure.

FIG. 5 shows a block diagram of a device for switching a band according to an example of the present disclosure. Referring to FIG. 5, the device 500 includes a processing module 501, configured to determine a switching mode for a band based on a priority of at least one band supported by a terminal.

In some embodiments, referring to FIG. 6, the device 500 further includes a receiving module 502, configured to receive priority indication signaling transmitted by a network device. The priority indication signaling is configured to indicate the priority of the at least one band.

In some embodiments, the priority indication signaling includes a first quantity of bits. Each of the first quantity of bits is configured to indicate a priority of a corresponding band.

In some embodiments, in a case where a second quantity of bands supported by the terminal is less than the first quantity, a second quantity of high-order bits in the first quantity of bits indicate priorities of corresponding bands. Alternatively, in a case where a second quantity of bands supported by the terminal is less than the first quantity, a second quantity of low-order bits in the first quantity of bits indicate priorities of corresponding bands.

In some embodiments, the priority indication signaling includes a third quantity of bits. Code points corresponding to the third quantity of bits are configured to indicate priorities of all bands.

In some embodiments, in a case where the priority indication signaling is invalid or not configured, the at least one band has a low priority by default. Alternatively, in a case where the priority indication signaling is invalid or not configured, the at least one band has a high priority by default.

In some embodiments, the priority indication signaling is in the form of at least one of RRC signaling, a MAC CE, or DCI signaling.

In some embodiments, referring to FIG. 6, the device 500 further includes a transmitting module 503, configured to transmit capability information to the network device. The capability information is configured to indicate the at least one band supported by the terminal.

In some embodiments, the capability information is further configured to indicate a priority of the at least one band.

In some embodiments, the capability information is further configured to indicate an index identifier. The index identifier has a correspondence relationship with the at least one band supported by the terminal and the priority of each of the at least one band.

In some embodiments, the switching mode includes any one of:
supporting mutual switching between bands having a same priority;
supporting mutual switching between bands having different priorities and not supporting mutual switching between bands having a same priority;
supporting switching from a band having a low priority to a band having a high priority, and not supporting switching from the band having the high priority to the band having the low priority; or
supporting switching from a band having a high priority to a band having a low priority, and not supporting switching from the band having the low priority to the band having the high priority.

In some embodiments, each of the at least one band includes at least one carrier, and carriers belonging to a same band have a same priority.

It needs to be noted that the device 500 according to the above embodiments, in realizing its functions, is merely exemplified by the division of each of the above functional modules. In actual application, the above functions may be assigned to be accomplished by different functional modules according to the needs. That is, the internal structure of the device 500 may be divided into different functional modules to accomplish all or part of the above functions. In addition, the device 500 provided by the above embodiments belongs to a same concept as the method embodiments, and its realization process is detailed in the method embodiments, which may not be repeated.

FIG. 7 shows a block diagram of a device for switching a band according to an example of the present disclosure. Referring to FIG. 7, the device 700 includes a processing module 701, configured to determine a priority of at least one band supported by a terminal. The priority of the at least one band is configured to be used by the terminal to determine a switching mode for a band.

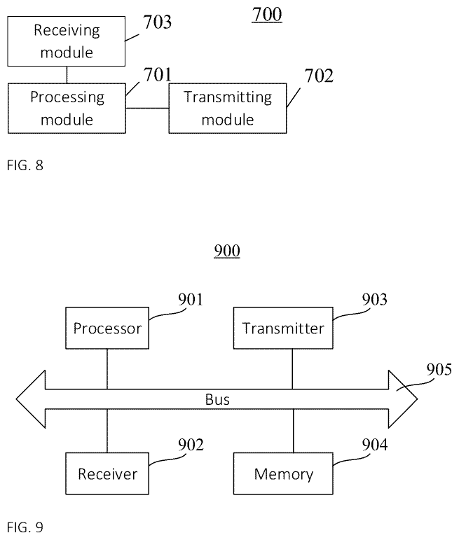

In some embodiments, referring to FIG. 8, the device 700 further includes a transmitting module 702, configured to transmit priority indication signaling to the terminal. The priority indication signaling is configured to indicate the priority of the at least one band.

In some embodiments, the priority indication signaling includes a first quantity of bits. Each of the first quantity of bits is configured to indicate a priority of a corresponding band.

In some embodiments, in a case where a second quantity of bands supported by the terminal is less than the first number, a second quantity of high-order bits in the first quantity of bits indicate priorities of corresponding bands. Alternatively, in a case where a second quantity of bands supported by the terminal is less than the first number, a second quantity of low-order bits in the first quantity of bits indicate priorities of corresponding bands.

In some embodiments, the priority indication signaling includes a third quantity of bits. Code points corresponding to the third quantity of bits are configured to indicate priorities of all bands.

In some embodiments, in a case where the priority indication signaling is invalid or not configured, the at least one band has a low priority by default. Alternatively, in a case where the priority indication signaling is invalid or not configured, the at least one band has a high priority by default.

In some embodiments, the priority indication signaling is in the form of at least one of RRC signaling, a MAC CE, or DCI signaling.

In some embodiments, referring to FIG. 8, the device 700 further includes a receiving module 703, configured to receive capability information transmitted by the terminal. The capability information is configured to indicate the at least one band supported by the terminal.

In some embodiments, the capability information is further configured to indicate the priority of the at least one band.

In some embodiments, the capability information is further configured to indicate an index identifier. The index identifier has a correspondence relationship with the at least one band supported by the terminal and the priority of each of the at least one band.

In some embodiments, the switching mode includes any one of:
supporting mutual switching between bands having a same priority;
supporting mutual switching between bands having different priorities and not supporting mutual switching between bands having a same priority;
supporting switching from a band having a low priority to a band having a high priority, and not supporting switching from the band having the high priority to the band having the low priority; or
supporting switching from a band having a high priority to a band having a low priority, and not supporting switching from the band having the low priority to the band having the high priority.

In some embodiments, each of the at least one band includes at least one carrier, and carriers belonging to a same band have a same priority.

It needs to be noted that the device 700 provided in the above embodiments, in realizing its functions, is merely exemplified by the division of each of the above functional modules. In actual application, the above functions may be assigned to be accomplished by different functional modules according to the needs. That is, the internal structure of the device 700 may be divided into different functional modules to accomplish all or part of the above functions. In addition, the device 700 provided by the above embodiments belongs to a same concept as the method embodiments, and its realization process is detailed in the method embodiments, which may not be repeated.

FIG. 9 shows a schematic structural diagram of a communication device according to an example of the present disclosure. The communication device 900 includes a processor 901, a receiver 902, a transmitter 903, a memory 904, and a bus 905.

The processor 901 includes one or more processing cores, and performs various functional applications and information processing by running software programs and modules.

The receiver 902 and the transmitter 903 may be implemented as a communication component. The communication component may be a communication chip.

The memory 904 is connected to the processor 901 via the bus 905.

The memory 904 may be configured to store at least one program code. The processor 901 is configured to execute the at least one program code to implement the various steps in the method embodiments.

In addition, the communication device 900 may be a terminal or a network device. The memory 904 may be implemented by any type of volatile or non-volatile storage devices or a combination thereof. The volatile or non-volatile storage devices include, but are not limited to: a disk or CD-ROM, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In an example, a non-transitory computer-readable storage medium is further provided. The non-transitory computer-readable storage medium stores executable program codes. The executable program codes are loaded and executed by one or more processors to implement the method for switching the band provided in each of the method embodiments and performed by a communication device.

In an example, a chip (not shown) is provided. The chip includes at least one of programmable logic circuits or program instructions. The chip, when running on a terminal or a network device, is configured to perform the method for switching the band as provided in each of the method embodiments.

In an example, a communication system (not shown) is provided. The communication system includes a terminal and a network device. The terminal is configured to implement the method for switching the band as described in the disclosure, and the network device is configured to implement the method for switching the band as described in the disclosure.

In an example, a computer program product is provided. The computer program product, when executed by one or more processors of a terminal or a network device, is configured to perform the method for switching the band as provided in each of the method embodiments.

Those of ordinary skill in the art may understand that all or some of the steps for implementing the embodiments in the disclosure may be accomplished by hardware, or may be accomplished by a program instructing relevant hardware. The program may be stored in a non-transitory computer-readable storage medium. The non-transitory computer-readable storage medium may be a read-only memory, a disk, or a CD-ROM, etc.

The above mentioned are merely embodiments of the present disclosure, and are not intended to limit the present disclosure. Any modifications, equivalent replacements, improvements, etc. made within the spirit and principles of the present disclosure shall be included in the scope of protection of the present disclosure.

1. A method for switching a band, performed by a terminal, comprising:
determining a switching mode for a band based on a priority of at least one band supported by the terminal.

2. The method according to claim 1, further comprising:
receiving priority indication signaling transmitted by a network device, wherein the priority indication signaling is configured to indicate the priority of the at least one band.

3. The method according to claim 2, wherein the priority indication signaling comprises a first quantity of bits, and each of the first quantity of bits is configured to indicate a priority of a corresponding band.

4. The method according to claim 3, wherein
a second quantity of high-order bits in the first quantity of bits indicate the priorities of the corresponding bands, in a case where the second quantity of bands supported by the terminal is less than the first quantity; or
a second quantity of low-order bits in the first quantity of bits indicate the priorities of the corresponding bands, in a case where the second quantity of bands supported by the terminal is less than the first quantity.

5. The method according to claim 2, wherein the priority indication signaling comprises a third quantity of bits, and code points corresponding to the third quantity of bits are configured to indicate priorities of all bands; or
wherein the at least one band has a low priority by default, in a case where the priority indication signaling is invalid or not configured; or
wherein the at least one band has a high priority by default, in a case where the priority indication signaling is invalid or not configured.

6.-7. (canceled)

8. The method according to claim 1, further comprising:
transmitting capability information to a network device, wherein the capability information is configured to indicate the at least one band supported by the terminal.

9. The method according to claim 8, wherein the capability information is further configured to indicate the priority of the at least one band; or
wherein the capability information is further configured to indicate an index identifier, and the index identifier has a correspondence relationship with the at least one band supported by the terminal and a priority of each of the at least one band.

10. (canceled)

11. The method according to claim 1, wherein the switching mode comprises any one of:
supporting mutual switching between bands having a same priority;
supporting mutual switching between bands having different priorities and not supporting mutual switching between bands having a same priority;
supporting switching from a band having a low priority to a band having a high priority, and not supporting switching from the band having the high priority to the band having the low priority; or
supporting switching from a band having a high priority to a band having a low priority, and not supporting switching from the band having the low priority to the band having the high priority; or
wherein each of the at least one band comprises at least one carrier, and carriers belonging to a same band have a same priority.

12. (canceled)

13. A method for switching a band, performed by a network device, comprising:
determining a priority of at least one band supported by a terminal, wherein the priority of the at least one band is configured to be used by the terminal to determine a switching mode for a band.

14. The method according to claim 13, further comprising:
transmitting priority indication signaling to the terminal, wherein the priority indication signaling is configured to indicate the priority of the at least one band.

15. The method according to claim 14, wherein the priority indication signaling comprises a first quantity of bits, and each of the first quantity of bits is configured to indicate a priority of a corresponding band.

16. The method according to claim 15, wherein
a second quantity of high-order bits in the first quantity of bits indicate the priorities of the corresponding bands, in a case where the second quantity of bands supported by the terminal is less than the first quantity; or
a second quantity of low-order bits in the first quantity of bits indicate the priorities of the corresponding bands, in a case where the second quantity of bands supported by the terminal is less than the first quantity.

17. The method according to claim 14, wherein the priority indication signaling comprises a third quantity of bits, and code points corresponding to the third quantity of bits are configured to indicate priorities of all bands; or
wherein the at least one band has a low priority by default, in a case where the priority indication signaling is invalid or not configured; or
wherein the at least one band has a high priority by default, in a case where the priority indication signaling is invalid or not configured.

18.-19. (canceled)

20. The method according to claim 13, further comprising:
receiving capability information transmitted by the terminal, wherein the capability information is configured to indicate the at least one band supported by the terminal.

21. The method according to claim 20, wherein the capability information is further configured to indicate the priority of the at least one band; or
wherein the capability information is further configured to indicate an index identifier, and the index identifier has a correspondence relationship with the at least one band supported by the terminal and a priority of each of the at least one band.

22. (canceled)

23. The method according to claim 13, wherein the switching mode comprises any one of:
supporting mutual switching between bands having a same priority;
supporting mutual switching between bands having different priorities and not supporting mutual switching between bands having a same priority;
supporting switching from a band having a low priority to a band having a high priority, and not supporting switching from the band having the high priority to the band having the low priority; or
supporting switching from a band having a high priority to a band having a low priority, and not supporting switching from the band having the low priority to the band having the high priority; or
wherein each of the at least one band comprises at least one carrier, and carriers belonging to a same band have a same priority.

24.-26. (canceled)

27. A terminal, comprising:
one or more processors; and
a transceiver connected to the one or more processors,
wherein the one or more processors are collectively configured to load and execute executable instructions to:
determine a switching mode for a band based on a priority of at least one band supported by a terminal.

28. A network device, comprising:
one or more processors; and
a transceiver connected to the one or more processors,
wherein the one or more processors are collectively configured to load and execute executable instructions to perform the method for switching the band according to claim 13.

29. A communication system, comprising a terminal and a network device, wherein the terminal is configured to perform the method for switching the band according to claim 1, and the network device is configured to perform the method for switching the band according to claim 13.

30. A non-transitory computer-readable storage medium storing executable program codes, wherein the executable program codes are loaded and executed by one or more processors to implement the method for switching the band according to claim 1.
